(19) United States
(12) Patent Application Publication
(10) Pub. No.: US 2019/0245476 A1
(43) Pub. Date: Aug. 8, 2019

(54) System and Method for for Providing Solar Power from a Towable Micro Grid

(71) Applicant: ELECTRONIC POWER DESIGN, Houston, TX (US)

(72) Inventor: John Bradford Janik, Houston, TX (US)

(73) Assignee: Electronic Power Design, Houston, TX (US)

(21) Appl. No.: 15/888,276

(22) Filed: Feb. 5, 2018

(51) Int. Cl. H02S 10/40; H02S 20/30

(52) U.S. Cl. CPC H02S 10/40; H02S 20/30

(57) ABSTRACT

A system is disclosed comprising a solar field comprising a plurality of solar panels combined to supply electrical power and a movable sled wherein the solar field is mounted on the moveable sled. A method is disclosed for using the system.

### CROSS REFERENCE TO RELATED APPLICATIONS

This patent application claims priority from U.S. Provisional Patent Application Ser. No. 62/454,069 filed on Feb. 3, 2017 entitled A System and Method for Providing Solar Power from a Towable Micro Grid by John Janik, which is incorporated herein by reference in its entirety.

### BACKGROUND OF THE INVENTION

Providing power to remote areas is a problem because typical power supply sources such as a commercial power grid is not available in all remote locations

### FIELD OF THE INVENTION

The present invention relates to remote power generation and in particular to a moveable remote power generation system.

### SUMMARY OF THE INVENTION

A system and method for providing solar power from a towable micro grid is disclosed including but not limited to a solar field comprising a plurality of solar panels combined to supply electrical power to a remote area; and a movable sled supporting the solar field.

### BRIEF DESCRIPTION OF THE FIGURES

FIG. 1 is a plan view that depicts a schematic of an illustrative embodiment of a system and method for a towable microgrid solar power system;

FIG. 2 is a plan view that depicts a schematic of a land based fixed location solar panel installation;

FIG. 3 is a plan view that depicts a schematic of a roof based fixed location solar panel installation; and

FIG. 4 is a plan view that depicts a schematic of an illustrative embodiment of a towable solar panel installation.

### DETAILED DESCRIPTION

In a particular illustrative embodiment of the present invention, a system and method are provided that provide electrical power in remote locations where electrical power to remote locations where commercial electrical power is not readily available. In a particular illustrative embodiment of the invention, the system and method provide electrical power to a sand and gravel dredge which typically uses around 1 Mega Watt of electrical power. In another particular embodiment of the invention, the system and method can also provide for other remote power needs such as fielding applications and any other remote location needing power supplied when not locally available from an electrical utility grid. When a local electrical utility grid is available, these dredges and fielding applications typically prefer to connect to the local electric utility grid, however, when a local utility grid is not available nearby, construction of an expensive power line to supply power to the dredge or other application from the electrical grid. Connecting to the grid for power would also include all of the associated electric power bills including per kilowatt hour energy billing. Additional expenses which can be incurred in association with connection to the utility grid including but not limited to demand charges plus surcharges plus transmission and distribution charges plus taxes. Alternatively, dredges and fielding applications generate electrical power locally using diesel engine-generators, however, there can be substantial expenses incurred in running the diesel engine-generators, which consume expensive diesel fuel. Thus, the present invention is preferred as it generates electrical power in a remote location without connecting to an electrical utility grid or running the diesel engine-generators.

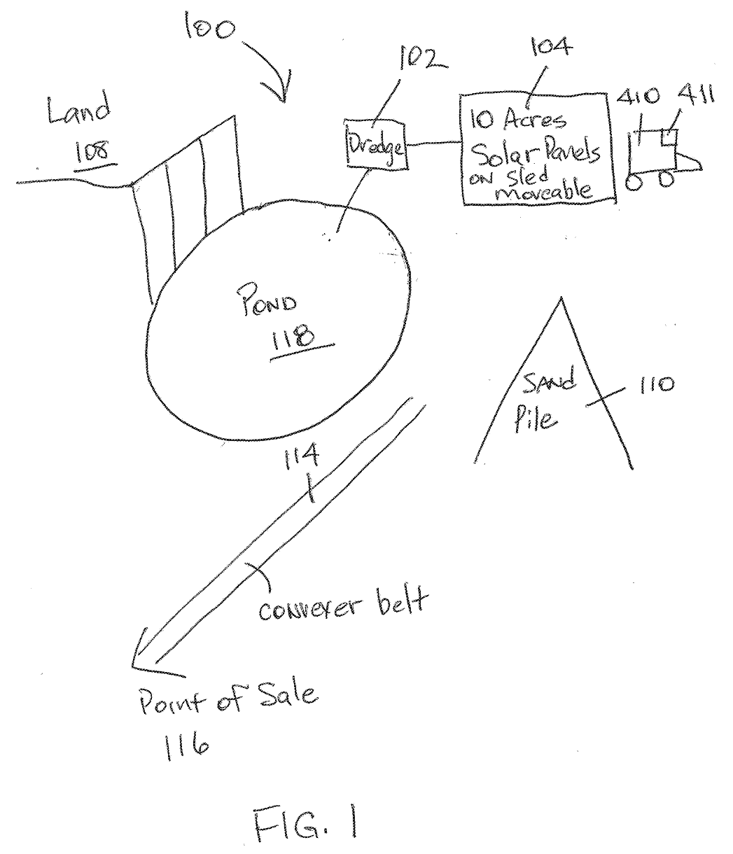

Turning now to FIG. 1, in a particular illustrative embodiment of the invention a solar field also referred to herein as a “micro-grid” of solar panels 104 for supplying power to a dredge 102 (which could also be a fielding application or another remote application where grid power is not available) is connected to a 1 MW solar field 104 (in a particular illustrative embodiment, about 10 acres of solar panels are provided as the solar field) directly to the dredge or fielding application. In a particular embodiment of the invention the system and method mitigate extremely intermittent power demand loads typical of a dredge 102. Electrical demand is higher at times such as when raising a ladder or cutting through a rough spot in the earth, etc. To mitigate the intermittent power demands, the present invention incorporates a plurality of equipment within an equipment enclosure 411 the equipment including but not limited to flywheels and/or batteries, or any other type of stored energy, along with an engine-generator set all of which located within tow truck 410 and generate the electricity directly onsite to supplement the solar field electrical output capacity. The inventor believes that the present invention will reduce the electrical power expense on a dredge by 66%. In additional illustrative embodiments the system and method provide electrical power to any remote equipment where local power is not economically available. In a particular embodiment, the solar field is towable so that it can be moved by a tow vehicle 410. In dredging application sand is dredged from a section of land 108 in the earth wherein the sand is removed to sand pile 110 forming pond 118. A sorter 112 is provided to separate find grain sand from larger grain sand. A conveyer belt 114 transports the larger grain sand to a point of sale 116.

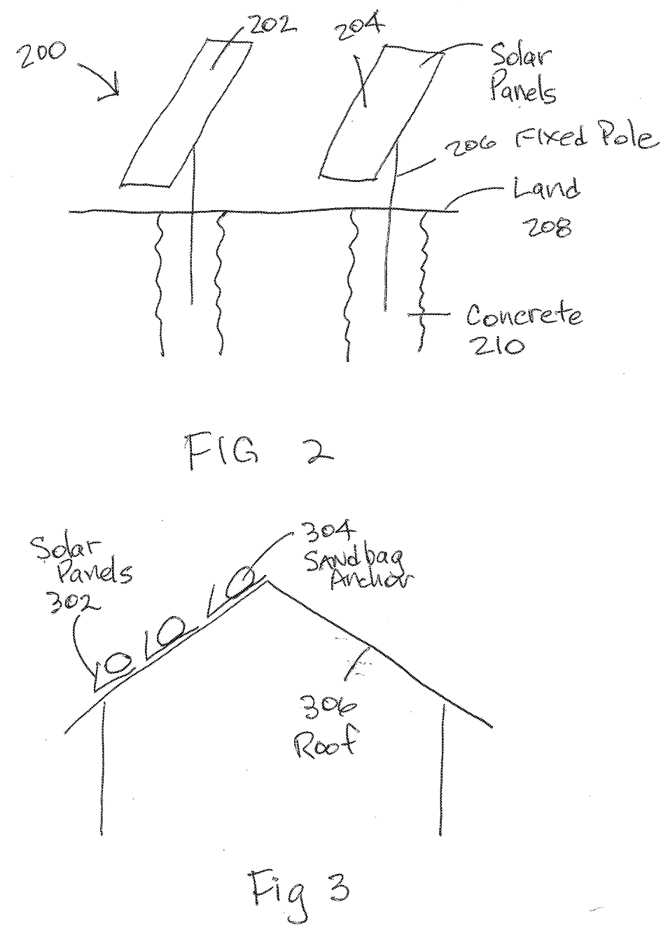

Turning now to FIG. 2, a fixed location land based solar field of solar panels installation 200 is depicted. The solar field uses solar panels 202 and 204 are fixed in the land 208 by fixed pole 206 and concrete 210.

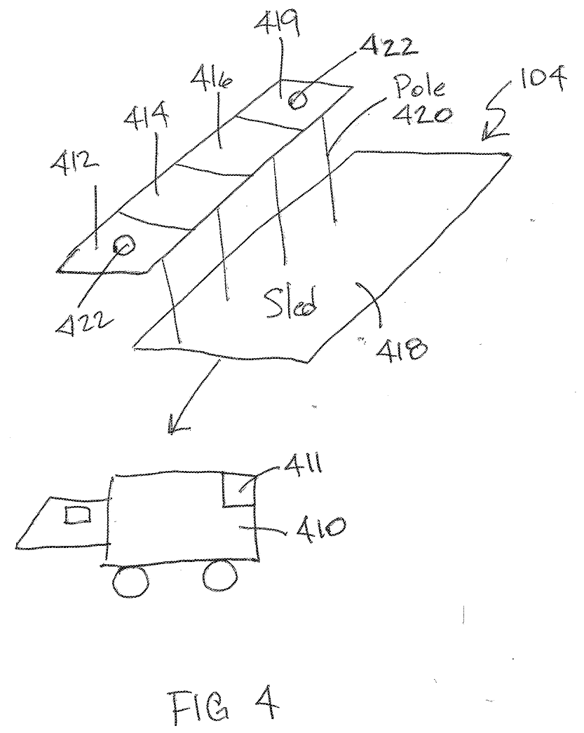

Turning now to FIG. 3, as shown in FIG. 3 a fixed location roof based solar field installation. Solar panels 302 in the solar field are weighted down and fixed to roof 306 by bolts 310 and sandbags 304.

Turning now to FIG. 4, as shown in FIG. 4 a towable solar field 104 is made up of a plurality of solar panels 412, 414, 416 and 419 attached by poles 420 to a towable sled 418. The towable sled is moved along the surface of the land 108 by the tow vehicle 410.

In another illustrative embodiment, a racking system 400 is provided that holds a solar field of solar panels stationary on land (including fixed mount systems and 1 or 2 axis tracking systems) and instead of installing by drilling holes or like driving long pole stands into the ground, a solar drag rack comprising a racking system attached to the solar drag rack comprising a skid or sled 418 with poles 420 and weighted assemblies 422 (for wind, etc.) such as sand bags so the racks attached to the sled can be dragged around by a bulldozer or tractor or by tow vehicle 410. In another embodiment the poles 420 are not used and weighted assembles are used without the poles. In another embodiment the weighted assembles are not used and poles are used without the weighted assembles. In a dredging sand and gravel pit environment, there are typically a “fines” area where fine gain, unsaleable sand is deposited. In another embodiment the solar panel lie directly on sled 418. On flat, barren, unusable land, the solar field could be dragged on top of this area or land 108. Then, as the operation moves, the solar panels 104 or solar panels 412, 414, 416 and 419 attached to the sled are dragged to a new area. Various systems and methods can be used to anchor the solar field solar racks for land use that would have mechanisms attached to drag the whole drag rack racking system assemblies around. In a particular embodiment, a plurality of solar panels 104 are combined to make up one acre of solar panels to supply 1 megawatt of power to a remote location.

The figures herein include block diagram and flowchart illustrations of methods, apparatus(s) and computer program products according to various embodiments of the present inventions. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus may be used to implement the functions specified in the block, blocks or flow charts. These computer program instructions may also be stored in a computer-readable medium or memory that can direct a computer or other programmable data processing apparatus to function in a particular manner, such that the instructions stored in the computer-readable medium or memory produce an article of manufacture including instructions which may implement the function specified in the block, blocks or flow charts. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block, blocks or flow charts.

Those skilled in the art should readily appreciate that programs defining the functions of the present inventions can be delivered to a computer in many forms, including but not limited to: (a) information permanently stored on non-writable storage media (e.g., read only memory devices within a computer such as ROM or CD-ROM disks readable by a computer I/O attachment); (b) information alterably stored on writable storage media (e.g., floppy disks and hard drives); or (c) information conveyed to a computer through communication media for example using wireless, baseband signaling or broadband signaling techniques, including carrier wave signaling techniques, such as over computer or telephone networks via a modem, or via any of networks.

The term “executable” as used herein means that a program file is of the type that may be run by the processor. In specific embodiments, examples of executable programs may include without limitation: a compiled program that can be translated into machine code in a format that can be loaded into a random access portion of the Computer Readable Medium and run by the processor; source code that may be expressed in proper format such as object code that is capable of being loaded into a random access portion of the Computer Readable Medium and executed by the processor; or source code that may be interpreted by another executable program to generate instructions in a random access portion of the Computer Readable Medium to be executed by the processor. An executable program may be stored in any portion or component of the Computer Readable Medium including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The Computer Readable Medium may include both volatile and nonvolatile memory and data storage components. Volatile components are those that do not retain data values upon loss of power. Nonvolatile components are those that retain data upon a loss of power. Thus, the Computer Readable Medium may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In a specific embodiment, the Load Sharing Processor may represent multiple Load Sharing Processors and/or multiple processor cores and the Computer Readable Medium may represent multiple Computer Readable Mediums that operate in parallel processing circuits, respectively. In such a case, the local interface may be an appropriate network that facilitates communication between any two of the multiple Processors, between any processor and any of the Computer Readable Medium, or between any two of the Computer Readable Mediums, etc. The local interface may comprise additional systems designed to coordinate this communication, including, for example, performing load balancing. The Load Sharing Processor may be of electrical or of some other available construction.

Although the programs and other various systems, components and functionalities described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components. Such technologies are generally well known by those skilled in the art and, consequently, are not described in detail herein.

Flowcharts and Block Diagrams of the Figures herein show the functionality and operation of various specific embodiments of certain aspects of the present inventions. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a Load Sharing Processor in a computer system or other system. The machine code may be converted from the source code, etc. If embodied in hardware, each block may represent a circuit or a number of interconnected circuits to implement the specified logical function(s).

Although the flowchart and block diagram of FIG. 1 show a specific order of execution, it is understood that the order of execution may differ from that which is depicted. For example, the order of execution of two or more blocks may be scrambled relative to the order shown. Also, two or more blocks shown in succession in FIG. 1 may be executed concurrently or with partial concurrence. Further, in some embodiments, one or more of the blocks shown in FIG. 1 may be skipped or omitted. In addition, any number of counters, state variables, warning semaphores, or messages might be added to the logical flow described herein, for purposes of enhanced utility, accounting, performance measurement, or providing troubleshooting aids. It is understood that all such variations are within the scope of the present inventions.

Any logic or application described herein that comprises software or code can be embodied in any non-transitory computer-readable medium, such as computer-readable medium, for use by or in connection with an instruction execution system such as, for example, a Load Sharing Processor in a computer system or other system. In this sense, the logic may comprise, for example, statements including instructions and declarations that can be fetched from the computer-readable medium and executed by the instruction execution system. In the context of the present inventions, a “computer-readable medium” may include any medium that may contain, store, or maintain the logic or application described herein for use by or in connection with the instruction execution system.

The computer-readable medium may comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random-access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The Processor may further include a network interface coupled to the bus and in communication with the network. The network interface may be configured to allow data to be exchanged between computer and other devices attached to the network or any other network or between nodes of any computer system or the video system. In addition to the above description of the network, it may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, the network interface may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

What is claimed is:

1. A system comprising:
a solar field comprising a plurality of solar panels combined to supply electrical power; and
a movable sled wherein the solar field is mounted on the moveable sled.

2. The system of claim 1 further comprising:
a tow vehicle that drags the movable sled to relocate the solar field;
an equipment room on the tow vehicle containing intermittent power surge mitigation equipment.

3. The system of claim 1, wherein the plurality of solar panels is divided up into a plurality of solar panel groups and each of the groups mounted onto one of a plurality of moveable sleds.

4. A method comprising:
towing in a remote area away from a utility grid, a moveable plurality of solar panels on a moveable sled combined to supply power to the remote area; and
towing the movable sled supporting the solar panels to another location.

5. The method of claim 4, wherein the plurality of solar panels are divided onto a plurality of moveable sleds.
